(19) United States
(12) Patent Application Publication
(10) Pub. No.: US 2009/0186183 A1
(43) Pub. Date: Jul. 23, 2009

(54) LINER AND ALSO THE USE THEREOF

(75) Inventors: Uwe MICHEL, Berlin (DE); Bernard MUSSIG, Seevetal (DE); Andreas WIECK, Halstenbek (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Berlin (DE)

(21) Appl. No.: 12/357,040

(22) Filed: Jan. 21, 2009

(30) Foreign Application Priority Data
Jan. 22, 2008 (DE) 102008005566.2

(51) Int. Cl. B32B 9/02

(52) U.S. Cl. 428/41.3

(57) ABSTRACT

Liner comprising a monoaxially oriented film composed of at least two layers coextruded with one another, a core layer of polypropylene, a coextrusion layer and, if desired, further layers, a release coating being applied on the outer side of the coextrusion layer.

The invention relates to a liner and also to the use thereof.

Adhesive tapes coated on one or both sides with adhesives are usually, at the end of the production operation, wound to a roll in the form of an Archimedean spiral. In order to prevent the adhesives of double-sided adhesive tapes coming into contact with one another, or in order to prevent the adhesive of single-sided adhesive tapes from sticking to the carrier, the adhesive tapes, prior to winding, are applied to a liner material, which is wound up together with the adhesive tape. The skilled person refers to such liner materials simply as liners. As well as for the lining of single-sided or double-sided adhesive tapes, liners are also used to line labels.

Generally speaking, liners are release papers (papers with single-sided or double-sided silicone coating). Also used, to a minor extent, are polyester, polypropylene and polyethylene films with a silicone coating. Film-based liners are referred to by the skilled person for self-adhesive products as release films.

The films for polyolefin liners of this kind are produced by blown-film or flat-film extrusion. Liners serve for the production operation (coating of pressure-sensitive adhesive, drying, transfer of the dry adhesive to a substrate, and removal of the liner). The liner may also serve for storage (for example in the case of double-sided adhesive tapes). The liner lines the layer of pressure-sensitive adhesive and is removed in application prior to bonding.

For numerous applications in the further-processing sector (referred to as converting applications), such as the production of diecuts, for example, it is not possible to use release papers, since in cases of fluctuation in humidity the papers are not dimensionally stable, and, furthermore, the thickness tolerances are often too high. Moreover, following the diecutting operation, paper fibres originating from the release paper adhere to the cut edges of the adhesive tape, which is something that is not acceptable for hygiene applications and electronic applications of the diecut, for example diecuts for the assembly of flat screens or mobile telephones.

Employed for such applications nowadays are siliconized polyester films with a thickness of 50 or 75 μm. Although they do not have the stated disadvantages of the release papers, they are relatively expensive and available virtually only in colourless form.

Liners possessing a coloured transparency, however, may be useful for observation in the machine. Coloured liners are beneficial for the control of the diecutting operation (for example, the control of web edges). Coloured polyester films, however, are extremely expensive, and attempts are therefore made to apply the colour via a coating operation (see EP 1 234 863 A1).

It is an object of the invention to provide a liner which does not have the stated disadvantages of release papers or of polyester release films.

This object is achieved by means of a liner as described in greater detail hereinbelow. Further embraced by the concept of the invention is the use of the liner of the invention.

The invention accordingly provides a liner comprising a monoaxially oriented film composed of at least two layers coextruded with one another, a core layer of polypropylene, a coextrusion layer and, if desired, further layers, a release coating being applied on the outer side of the coextrusion layer.

In order to set sufficiently high stresses at 1% and 10% extension, but also to set not too high a flexural rigidity or brittleness, the draw ratio of the liner film is matched to the particular polypropylene base material. A draw ratio of 1:6, for example, indicates that a section of the primary film 1 m in length produces a section 6 m long in the drawn film. The draw ratio is often also designated as a ratio of the linear speed prior to orientation to the linear speed after orientation. In the case of this invention the draw ratio of the film is preferably between 1:5 and 1:10, more particularly between 1:6 and 1:9.

In one preferred version, the film in machine direction (longitudinal direction) possesses a specific tensile force at 1% extension of at least 15, preferably at least 20 N/cm and/or a specific tensile force at 10% extension of at least 100, preferably at least 130 N/cm.

According to one further advantageous embodiment of the invention, the specific maximum tensile force is at least 170, preferably at least 190 N/cm and/or the tear propagation resistance in cross direction is at least 200, more particularly at least 400 N/mm.

To calculate strength values, the specific force values are divided by the thickness of the liner. The thickness of the liner is situated preferably in a range from 30 to 120 μm, preferably 40 to 100 μm, more preferably 50 to 75 μm. With further preference it is situated in the range from 45 to 55 or from 70 to 80 μm, so that the diecutting machines do not have to be readjusted when products are switched to 50 or 75 μm polyester liners that are nowadays customarily used.

According to a further advantageous embodiment a release coating is applied to each of the outer sides of the carrier, the release coatings preferably having different release forces with respect to a layer of adhesive.

The film for the liner of the invention can be produced in an analogy to the relatively simple extrusion process for monoaxially oriented polypropylene films. Films of that kind are used as carrier material for tear-open strips or strapping tapes. These carrier films are coated on one side with a pressure-sensitive adhesive, preferably with use of a primer. A liner, in contrast, is not a constituent of an adhesive tape or label, but only an auxiliary means for its production or storage or for its further processing by diecutting. Furthermore, unlike a carrier, a liner is not joined firmly to a layer of adhesive.

Suitable PP film base materials for the core layer of the liner of the invention are commercially available polypropylene homopolymers or polypropylene copolymers. For the subject matter of the invention it is preferred to use impact-modified polypropylene copolymers with ethylene or butylene as comonomer. The melt indices of the stated polymers must be situated in the range suitable for flat-film extrusion. This range ought to be between 0.3 and 15 g/10 min, preferably in the range of 0.8 and 5 g/10 min (measured at 230° C./2.16 kg).

The flexural modulus of the polypropylene is preferably in the range from 1000 to 1600, more particularly in the range from 1200 to 1400 MPa.

The polypropylene film of the core layer may comprise further polymers, polyethylene for example, including ethylene copolymers such as EVA or LLDPE or propylene polymers not already mentioned.

Additionally, it is possible to use further additives that are customary for polypropylene, examples being dyes, pigments, fillers, antioxidants, light-stabilizers, nucleating agents or processing assistants. These additives preferably do not negatively influence the curing of a silicone layer.

The film of the core layer is preferably coloured or white.

When adhesive tapes lined with release films are being diecut, it is possible, as a result of incorrect setting of the machine or of excessively high thickness tolerances of the liner, for the liner film to be partially cut. When the diecut is being dispensed, this may result in the extraction of parts of the polypropylene film of the liner or in the sticking of the adhesive to the polypropylene base layer of the liner.

On one side of the core layer of the liner of the invention, therefore, a coextrusion layer is provided, more particularly on the side of the liner intended for diecutting. According to one preferred embodiment of the invention, the coextrusion layer is tougher than the core layer.

For the purpose, for example, of a good flat lie on the part of the core layer during siliconization, it is possible for there to be applied, on the other side of the core layer, a further layer, which is coextruded together with the core layer and the coextrusion layer.

The toughness of a film depends on the crystallinity of the film, which is influenced by the shaping operation, the draw ratio and the crystallite melting points of the polymers employed. The core layer is preferably composed of a polypropylene having a crystallite melting point of 150° C. to 167° C., more preferably 160° C. to 167° C., while the coextrusion layer preferably comprises a polypropylene polymer or an ethylene-containing copolymer having a crystallite melting point of below 150° C., preferably below 140° C. The fraction of these polymers for the coextrusion layer is preferably at least 50% by weight. Examples of polymers of this kind are random polypropylene copolymers, polypropylene terpolymers, polypropylene plastomers (for example, Vistamaxx® or Versify®), polyethylene plastomers (for example Exact® or Tafmer®, EPM, EPDM, LDPE, VLDPE or LLDPE).

Where the polymer of the coextrusion layer contains little or no propylene, it is blended, in order to improve the adhesion between core layer and coextrusion layer, preferably with a polypropylene-containing polymer, more particularly the main component of the base layer, the fraction being preferably at least 20% by weight.

The liner of the invention is equipped on the outer side of the coextrusion layer with a release coating (non-stick coating). According to a further advantageous embodiment of the invention it is possible for there to be a release coating applied to both outer layers of the carrier. Release coatings may be composed of silicones, acrylates (for example Primal® 205), stearyl compounds such as polyvinyl stearyl carbamate or chromium stearate complexes (for example, Quilon® C), reaction products of maleic anhydride copolymers and stearyl amine, or reaction products of polyvinyl alcohol and stearyl isocyanate. Preference is given to a silicon-based release coating. The silicone may be applied solventlessly (in 100% form or as a dispersion), or on a solvent-borne basis and may be crosslinked by radiation, thermally for example, via a condensation, addition or free-radical reaction, or physically (for example, by virtue of a block structure). If desired, the release coating may also be applied by coextrusion (for example with an external layer comprising polyvinyl stearylcarbamate or silicone-grafted polyethylene). Preferably there are silicone layers applied to both sides of the film, and with particular preference these silicone layers have different release forces with respect to a layer of adhesive.

In order to avoid adverse effects of the release coating on the mechanical properties of the film, solvent-free silicones with thermal or radiation-induced crosslinking are particularly preferred, especially vinylpolydimethylsiloxanes. These silicones are preferably crosslinked with methylhydrosiloxanes in the presence of a platinum or rhodium catalyst or by EB/UV radiation.

For this purpose it is possible to use, for example, the commercially available, addition-crosslinking silicone release system “Dehesive 940A” from Wacker-Chemie with an associated catalyst system, which is applied in the non-crosslinked state and then subsequently, in the applied state, is crosslinked.

As crosslinkable silicone it is possible to employ the silicone systems that are customarily used for release coating. These include mixtures of crosslinking catalysts and what are called thermally curable condensation-crosslinking or addition-crosslinking siloxanes. It is also possible, furthermore, to use photoactive catalysts, known as photoinitiators, in combination with UV-curable, cationically crosslinking epoxide-based and/or vinyl ether-based siloxanes, and/or UV-curable, free-radically crosslinking siloxanes such as, for instance, acrylate-modified siloxanes. A further possibility is the use of electron beam curable silicone acrylates. Depending on their intended use, such systems may also comprise further additions such as stabilizers or flow control assistants.

Furthermore, there are different kinds of organo-polysiloxane compositions known which crosslink by heating or irradiation. Mention may be made of compositions of the kind described, for example, in EP 0 378 420 A1 which crosslink by addition reaction, namely by the temperature treatment of a mixture comprising organopolysiloxane with hydrogen atoms attached directly to the silicon atoms and an organo-polysiloxane having vinyl groups attached directly to the silicon atoms, in the presence of a hydrosilylation catalyst.

Photopolymerizable organopolysiloxane compositions can be used as well. Examples include compositions which are crosslinked through the reaction between organo-polysiloxanes which have hydrocarbon radicals, substituted by (meth)acrylate groups, attached directly to the silicon atoms, this crosslinking taking place in the presence of a photosensitizer (see EP 0 168 713 B1, DE 38 20 294 C1). It is likewise possible to use compositions where the crosslinking reaction between organopolysiloxanes which have mercapto-substituted hydrocarbon attached directly to the silicon atoms and organopolysiloxanes having vinyl groups attached directly to the silicon atoms is brought about in the presence of a photosensitizer. Such compositions are described in U.S. Pat. No. 4,725,630 A1, for example.

In the case where the organopolysiloxane compositions described in DE 33 16 166 C1 are used, which have epoxy-substituted hydrocarbon radicals attached directly to the silicon atoms, the crosslinking reaction is induced by the release of a catalytic quantity of acid which is obtained through the photodecomposition of added onium salt catalysts. Other organopolysiloxane compositions curable by means of a cationic mechanism are materials which have, for example, propenyloxysiloxane end groups.

Thermosetting release coatings are frequently multi-component systems which are composed typically of the following components:
a) A linear or branched dimethylpolysiloxane which is composed of about 80 to 200 dimethylpolysiloxane units and is stopped at the chain ends with vinyldimethylsiloxy units. Typical representatives are, for example, solvent-free, addition-crosslinking silicone oil with terminal vinyl groups, such as Dehesive® 921 or 610, both commercially available from Wacker-Chemie GmbH.
b) A linear or branched crosslinker which is composed customarily of methylhydrosiloxy and dimethyl-siloxy units, the chain ends being satisfied either with trimethylsiloxy groups or dimethylhydrosiloxy groups. Typical representatives of this class of product are, for example, hydropolysiloxanes having a high reactive Si—H content, such as the crosslinkers V24, V90 or V06 available commercially from Wacker-Chemie GmbH.
c) A silicone MQ resin which as its M unit has vinyldimethylsiloxy units as well as the trimethylsiloxy units customarily used. Typical representatives of this group are, for example, the release-force regulators CRA® 17 or CRA® 42, available commercially from Wacker-Chemie GmbH.
d) A silicone-soluble platinum catalyst such as, for example, a platinum divinyltetramethyldisiloxane complex which is customarily referred to as the Karstedt complex and is available commercially, for example, under the name Katalysator OL from Wacker-Chemie GmbH.

The silicones used in accordance with the invention, preferably silicone oils are polydisperse mixtures of linear or cyclic siloxane chains of different lengths and with different substitution. The mixtures are formed in catalyzed synthesis processes. The polysiloxanes are composed of alternating atoms of silicon and oxygen, and so the characteristic feature is the Si—O—Si (=siloxane) bond in the molecular assembly. On the two remaining valencies of the silicon, a variety of substituents are possible. Given their chemically correct name, therefore, the silicone oils in question are polydimethylsiloxanes generally abbreviated to PDMS. They are characterized by the formula below:

Structure of linear (left) and cyclic (right) polydimethylsiloxanes

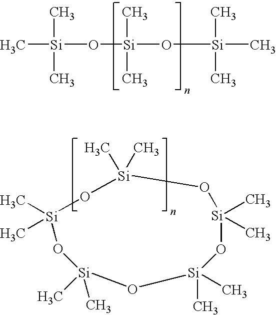

The radicals on the silicon may also be satisfied with further siloxane bonds; in this way, branched silicones and crosslinked silicones are formed. The former then form the silicone resins, the latter the silicone elastomers.

Depending on the functionality of the silicon group (mono-, di-, tri- or tetra-functional) the symbolic notations M, D, T and Q have been introduced:

[M]=R₃SiO_{1/2}

[D]=R₂SiO_{2/2}

[T]=RSiO_{3/2}

[Q]=SiO_{4/2}

The following groups can be distinguished:
linear polysiloxanes: are constructed in chain form from difunctional siloxane units and contain monofunctional end groups; structural type [MDₙM] or R₃SiO[R₂SiO]ₙSiR₃,
in the pictorial formula (R═CH₃).
branched polysiloxanes: are constructed in cyclic or chain form from di-, tri- or tetra-functional siloxane units; structural type [MₙDₘTₙ].
cyclic polysiloxanes: are constructed in cyclic form from difunctional siloxane units; structural type [Dₙ].
crosslinked polymers: are chain-form or cyclic molecules which are linked via T and Q units to form two-dimensional or three-dimensional networks.

The side of the film that is intended to have a release coating is preferably pretreated on the surface for the purpose of better adhesion of the release coating. These pre-treatments may be chemical coatings or treatments from the gas phase (for example, fluorine-containing gases), or physical operations such as flame treatment or plasma treatment and, in particular, corona treatment.

Owing to the outstanding properties of the liner, it is possible with advantage to use a single-sided or double-sided adhesive tape, adhesive-tape diecut or label to line the adhesive layer, particularly when the adhesive coating is acrylate-based.

In a further advantageous use of the liner it lines a double-sided adhesive tape which is processed to diecuts in a diecutting process.

The single-sided or double-sided adhesive tape, the adhesive-tape diecuts or labels may further comprise a carrier, for example, a tissue, a film, a woven fabric, a polyolefin foam or a nonwoven. Preferably, the adhesive tape is double-sidedly adhesive and preferably comprises a carrier made from thin paper (tissue), nonwoven, foam material or film. The films may be, for example, biaxially oriented polyester or polypropylene films.

Suitable pressure-sensitive adhesives are described in D. Satas, Handbook of Pressure Sensitive Adhesive Technology (Van Nostrand Reinhold). Suitability is possessed more particularly by pressure-sensitive adhesives based on acrylate, natural rubber, thermo-plastic styrene block copolymer, polyisobutylene or silicone. Preference is given to acrylate PSAs, which may be applied as a dispersion, hotmelt or solution. To optimize the properties the self-adhesive composition employed may have been blended with one or more additives such as tackifiers (resins), plasticizers, fillers, pigments, UV absorbers, light-stabilizers, ageing inhibitors, crosslinking agents, crosslinking promoters or elastomers. The layer of adhesive may be crosslinked as a result of heat or high-energy beams.

For the purposes of this invention the general expression “adhesive tape” encompasses all sheet-like structures such as two-dimensionally extended films or film sections, tapes with extended length and limited width, tape sections and the like, and finally also diecuts or labels.

The advantages of the invention are manifested especially in the embodiment of the liner with a coloured film. The colour need not be applied via a coating operation; instead, the coextrusion of the layers avoids this additional operation and the use of solvents. Furthermore, different adhesive tapes or other products may be characterized by the colour of the liner, which prevents confusion during the application of the adhesive tapes. Coloured liners are beneficial for the control of the diecutting operation (for example the control of web edges).

All of the parameters mentioned are determined by the following test methods:

Thickness: DIN 53370

Tensile strength: DIN 53455-7-5 in machine direction

Tension at 1% or 10% extension: DIN 53455-7-5 in machine direction

Breaking extension: DIN 53455-7-5 in machine direction

Melt index: DIN 53735
The “melt flow ratio” (MFR) melt index is measured in accordance with DIN 53735. For polyethylenes, melt indices are usually stated in g/10 min at 190° C. under a weight of 2.16 kg, and for polypropylenes accordingly, albeit at a temperature of 230° C.

Flexural modulus: ASTM D 790 A

Density: ASTM D 792

Crystallite melting point: Determination by DSC to ISO 3146 or MTM 15902 (Basel method)

The purpose of the text below is to illustrate the invention with reference to examples, without restricting it as a result.

### EXAMPLES

Raw Materials:

Dow 7C06:

PP-BC, MFI 1.5 g/10 min, non-nucleated, flexural modulus 1280 MPa, crystallite melting point 164° C. (Dow Chemical)

Dow Inspire 404.01:

Polypropylene, MFI 3 g/10 min, nucleated (with a polymeric nucleating agent as per US 2003/195300 A1), flexural modulus 2068 MPa, crystallite melting point 164° C. (Dow Chemical)

Moplen HP 501 D:

Copolymer with 1.5% by weight ethylene, MFI 0.7 g/10 min, non-nucleated, flexural modulus 1450 MPa, crystallite melting point 161° C. (Basell)

Borseal TD115BF:

Polypropylene terpolymer with ethylene and butylene, MFI 6.5 g/10 min, crystallite melting point 130° C., flexural modulus 700 MPa (Boralis)

Vistamaxx 3000:

Polyolefin elastomer, MFI 3 g/10 min, crystallite melting point 40° C., flexural modulus 40.2 MPa (Exxon Mobil Chemical)

ADK STAB NA-11 UH

Nucleating agent (Adeka Palamarole)

Remafingelb HG AE 30:

Coloured PP masterbatch with translucent pigment (Clariant Masterbatches)

TPM 1005 ES:

White PE master batch containing 50% by weight TiO₂ (Techmer Polymer Modifiers)

Dehesive 914:

Vinylpolydimethylsiloxane (Wacker Silicones)

Dehesive 920:

Vinylpolydimethylsiloxane (Wacker Silicones)

CRA 17:

Controlled release additive (Wacker Silicones)

Crosslinker V24:

Methylhydropolysiloxane (Wacker Silicones)

Catalyst OL:

Platinum catalyst in polydimethylsiloxane (Wacker Silicones)

### Example 1

A three-layer film is produced on a single-screw coextrusion unit with a flat die with a flexible die lip in one layer, followed by a chill roll station and a single-stage short-gap drawing unit.

The 65 μm core layer is composed of Dow 7C06, and the two outer layers, each 5 μm thick, are composed of 68.5% by weight ADK STAB NA-11 UH, 30% by weight Dow 7C06 and 1.5% by weight TPM 1005 ES. The die temperature is 235° C. and the draw ratio is 1:6.1. The resulting film is white.

Film Properties:

| | | |
|---|---|---|
| Thickness | 75 | μm |
| Spec. max. force | 200 | N/cm |
| Spec. force at 1% extension | 22 | N/cm |
| Spec. force at 10% extension | 140 | N/cm |

| | |
|---|---|
| Breaking extension | 19% |

The film is corona-pretreated on both sides and provided on each side, using a multiple-roll applicator unit, with a different release coating, each cured subsequently in a heating tunnel. As a result, the liner has a graded release action.

The release layers are composed of

100 parts by weight of Dehesive 920,

2.5 parts by weight of crosslinker V24 and

2.5 parts by weight of catalyst OL (easy release)

and

50 parts by weight of Dehesive 920,

50 parts by weight of CRA 17,

4 parts by weight of crosslinker V24 and

1.0 part by weight of catalyst OL (tight release).

This liner is coated with an acrylate hotmelt adhesive as per Example 6 of DE 101 45 229 A1 on the tight-release silicone side, the coat weight being 100 g/m², and then a corona-pretreated polyester film 12 μm thick is laminated in and the assembly is wound to a roll. In a second operation, this stock material is unwound and coated again in the same way, but this time on the uncoated polyester side, then wound to form a mother roll, and slit.

Produced from this product are square diecuts with an edge length of 20 mm, the width of the bridges in the matrix being 5 mm. The matrix is stripped, and the product, following the insertion of a covering liner Silphan M23 M74F (Siliconature) as a protective liner for the surface of the diecuts, is wound. In the dispensing apparatus, the diecuts, following removal of the liner, are transferred without disruptions from the liner to plastic parts (“pick & place”). If the depth of penetration of the slitting knife is increased by a further 3 μm, the liner does not undergo splicing.

### Example 2

A three-layer film is produced under conditions as in Example 1, the draw ratio being set at 1:8 and the layer thickness ratios being altered. As raw materials for the main layer, a mixture of 98.9% by weight Moplen HP 501 D, 0.9% by weight Remafingeib HG AE 30 and 0.2% by weight ADK STAB NA-11 UH is used. The coextrusion layers are composed of Borseal TD115BF. The film has a yellow transparency.

Film Properties:

| | | |
|---|---|---|
| Total thickness | 50 | μm |
| Thickness of the main layer | 45 | μm |
| Thickness of the coextrusion layers, each | 2.5 | μm |
| Spec. force at 1% extension | 22 | N/cm |
| Spec. force at 10% extension | 40 | N/cm |
| Spec. max. force | 160 | N/cm |

| | |
|---|---|
| Breaking extension | 12% |

The film is corona-pretreated on both sides and double-sidedly siliconized as in Example 1. This liner is coated with Aroset PS 1874 (solvent-based acrylate composition from Ashland) on the tight-release silicone side (coat weight 50 g/m² dry), the TLG 0700.8 (800 μm PE foam from Sekisui-Alveo) is laminated in and the assembly is wound to form a roll. In a second operation, this stock material is unwound and is coated again in the same way, but this time on the uncoated foam side, then wound to form a mother roll, and slit.

Further processing takes place as in Example 1. There are no processing problems.

### Example 3

A two-layer film is produced under conditions as in Example 1, the draw ratio being set at 1:7 and the layer-thickness ratios being altered. The main layer is composed of Inspire D 404.01 and the coextrusion layer is composed of Vistamaxx 3000. The film is colourless.

Film Properties:

| | | |
|---|---|---|
| Total thickness | 50 | μm |
| Thickness of the main layer | 45 | μm |
| Thickness of the coextrusion layer | 5 | μm |
| Spec. force at 1% extension | 28.7 | N/cm |
| Spec. max. force | 145 | N/cm |

| | |
|---|---|
| Breaking extension | 9.5% |

The film is pretreated on the coextrusion layer side with corona, and on this side it is provided with a silicone release varnish using a multiple-roll applicator unit, and the varnish is cured in a tunnel. The silicone release varnish is composed of a mixture of 96.5 parts by weight of Dehesive 914, 2.5 parts by weight of crosslinker V24 and 1 part by weight of catalyst OL.

The liner obtained is coated on the siliconized side with an adhesive at 40 g/m² (dry) using a coating bar. This adhesive contains 40% by weight natural rubber SMRL (Mooney 70), 10% by weight titanium dioxide, 37% by weight of a C₅ hydrocarbon resin having an R&B value of 95° C. and 1% by weight Vulkanox® BKF antioxidant, and takes the form of a 20% strength by weight solution in hexane.

After drying at 115° C., white label paper with a basis weight of 70 g/m² is laminated in, and the label stock material obtained is wound to form a mother roll. This material is used to produce labels 20 mm in size, in the same way as in Example 1, but with adaptation to the new film thickness; there are no processing problems.

### Comparative Example 1

A film is extruded on a single-screw extrusion unit with a flat die with a flexible die lip, from Inspire D 404.01, followed by a chill roll station and a single-stage short-gap drawing unit. The die temperature is 235° C. The draw ratio is 1:10.

Film Properties:

| | | |
|---|---|---|
| Thickness | 68 | μm |
| Spec. force at 1% extension | 50 | N/cm |
| Spec. max. force | 210 | N/cm |

| | |
|---|---|
| Breaking extension | 5.7% |

Further worksteps take place as in Example 1. In the old setting of the tool, of Example 1, the diecut matrix cannot be stripped without also stripping off the square diecuts. In order to adapt to the film thickness, therefore, the cutting was adapted so that the tool penetrates to a depth 7 μm greater. The diecutting matrix can be removed. When the diecuts are dispensed, some of them remain on the liner. After storage, almost all of the diecuts cannot be dispensed. If the depth of penetration of the slitting knife is increased by a further 3 μm, the liner undergoes splicing. (Cracks occur in the machine direction).

### Comparative Example 2

The liner is produced by siliconization as per Example 1, but on a commercially available, biaxially oriented polypropylene film 35 μm thick. The orientation ratio in the machine direction is 1:5 and the orientation ratio transverse to the machine direction is 1:9.

Film Properties:

| | | |
|---|---|---|
| Thickness | 35 | μm |
| Spec. force at 1% extension | 8 | N/cm |
| in the machine direction | | |
| Spec. max. force | 40 | N/cm |
| in the machine direction | | |

| | |
|---|---|
| Breaking extension | 215% |
| in the machine direction | |

Further processing take place as in Example 2. The diecutting is changed round for the new film thickness. The liner is colourless. On matrix stripping, the liner continually tears, since the tear propagation resistance of BOPP film is extremely low.

### Comparative Example 3

A three-layer film is produced in the same way as in Example 1, with the draw ratio set at 1:8. As raw materials for the main layer, a mixture of 98.9 parts by weight of Moplen HP 510 D, 0.9 part by weight Remafingelb HG AE 30 and 0.2 part by weight of ADK STAB NA-11 UH is used. The coextrusion layers are composed of Dow 7C06.

Film Properties:

| | | |
|---|---|---|
| Total thickness | 64 | μm |
| Thickness of the main layer | 60 | μm |
| Thickness of the coextrusion layers, each | 2.5 | μm |
| Spec. force at 1% extension | 21 | N/cm |
| Spec. force at 10% extension | 154 | N/cm |
| Spec. max. force | 180 | N/cm |

| | |
|---|---|
| Breaking extension | 17% |

The liner has a yellow transparency. On diecutting the problems described in Comparative Example 1 occur.

### Comparative Example 4

A release film based on an unoriented polypropylene film (76677 easy tight, colour 94333 from Huhtamaki) is used as a liner in accordance with Example 1. When the machine stops, the liner tears at the coating die for the hotmelt. On diecutting, the liner is stretched in some cases to such an extent that the dimensions of the diecuts deviate from the setpoint figure. On dispensing, the excessive stretching results in some of the diecuts detaching from the liner even upstream of the dispensing edge, and sticking to deflection rolls.

Film Properties:

| | | |
|---|---|---|
| Carrier thickness | 100 | μm |
| Spec. force at 1% extension | 12 | N/cm |
| Spec. force at 10% extension | 29 | N/cm |
| Spec. max. force | 51 | N/cm |

| | |
|---|---|
| Breaking extension | 800% |

What is claimed is:

1. Liner comprising a monoaxially oriented film composed of at least two layers coextruded with one another, a core layer of polypropylene, a coextrusion layer and, if desired, further layers, a release coating being applied on the outer side of the coextrusion layer.

2. Liner according to claim 1, which has a thickness of 45 to 55 μm or 70 to 80 μm.

3. Liner according to claim 1, wherein the film has
a draw ratio between 1:5 and 1:10,
in machine direction a specific force at 1% extension of at least 15, and/or
a specific force at 10% extension of at least 100.

4. Liner according to claim 1, which comprises a release coating applied on both outer sides of the carrier, the release coatings optionally having different release forces with respect to a layer of adhesive.

5. Liner according to claim 1, wherein the polypropylene of the core layer is a homopolymer or an impact-modified polypropylene copolymer.

6. Liner according to claim 1, wherein the polypropylene of the core layer has a flexural modulus of 1100 to 1600 and/or a crystallite melting point of 150° C. to 167° C.

7. Liner according to claim 1, wherein the core layer is white or coloured.

8. Liner according to claim 1, wherein the coextrusion layer comprises a polypropylene polymer or an ethylene-containing polymer having a crystallite melting point of below 150° C.

9. Liner according to claim 1, wherein the release coating is a silicone layer.

10. A combination comprising a liner according to claim 1 applied to an adhesive layer of a single-sided or double-sided adhesive tape, adhesive-tape diecut or label.

11. Combination according to claim 10, wherein the adhesive coating is acrylate-based.

12. Combination according to claim 10, wherein the liner lines a double-sided adhesive tape which is processed in a diecutting process.
